(19) United States
(12) Patent Application Publication
(10) Pub. No.: US 2013/0129574 A1
(43) Pub. Date: May 23, 2013

(54) CATALYTIC FILTER FOR FILTERING A GAS, COMPRISING A JOINT CEMENT INCORPORATING A GEOPOLYMER MATERIAL

(71) Applicants: Adrien Vincent, Cabannes (FR); Fabiano Rodrigues, Roussillon (FR); Emmanuel Fourdrin, Velleron (FR); Guillaume Klieber, L'isle-sur la sorgue (FR)

(72) Inventors: Adrien Vincent, Cabannes (FR); Fabiano Rodrigues, Roussillon (FR); Emmanuel Fourdrin, Velleron (FR); Guillaume Klieber, L'isle-sur la sorgue (FR)

(73) Assignee: SAINT-GOBAIN CENTRE DE RECHERCHES ET D'ETUDES EUROPEEN, Courbevoie (FR)

(21) Appl. No.: 13/700,840

(22) PCT Filed: Jun. 14, 2011
(86) PCT No.: PCT/FR2011/051342

§ 371 Date: Feb. 8, 2013

(30) Foreign Application Priority Data
Jun. 15, 2010 (FR) 1054729

(51) Int. Cl. F01N 3/022; B01D 53/94

(52) U.S. Cl. 422/169; 55/482; 156/244.13

(57) ABSTRACT

The invention relates to a filter structure, for filtering particulate-laden gases, comprising a plurality of honeycomb filtering elements, said structure being obtained by assembling said elements, which are joined together by means of a joint cement, said joint cement being an essentially inorganic, preferably mineral, composite comprising at least:
between 30 and 95% by weight of a filler formed by an assembly of grains, the melting point of which is above 1000° C., said grains having a diameter of greater than 30 microns; and
between 5 and 70% by weight of a binder matrix incorporating a geopolymer phase, said binder matrix comprising, in percentages by weight of the corresponding oxides:
SiO₂: between 20 and 80%,
Al₂O₃: between 3 and 50% and
R₂′O: between 3 and 30%, R₂′O representing the sum of the alkali metal oxides present in the binder matrix.

The invention relates to the field of particulate filters, especially those used in an engine exhaust line for eliminating the soot produced by burning a diesel fuel in an internal combustion engine.

Structures for filtering the soot contained in the exhaust gases of an internal combustion engine are well known in the prior art. These structures usually comprise at least one honeycomb filtering element, one of the faces of the structure allowing entry of the exhaust gases to be filtered and the other face allowing exit of the filtered exhaust gases. In the present description, the terms “monolith” and “monolithic element” are used indiscriminately to denote such filtering elements.

The structure comprises, between the entry and exit faces, an assembly of adjacent ducts or channels of mutually parallel axes and separated by porous filtering walls, which ducts are closed off at one or other of their ends so as to define inlet chambers opening onto the entry face and outlet chambers opening onto the exit face. For good sealing, the peripheral portion of the structure is usually covered with a cement, called coating cement in the description. The channels are alternately closed off in such an order that the exhaust gases, in the course of their passage through the honeycomb body, are forced to pass through the sidewalls of the inlet channels before rejoining the outlet channels. In this way, the particulates or soot particles are deposited and accumulate on the porous walls of the filter body. Usually, the filter bodies are made of a porous ceramic, for example cordierite or silicon carbide or else aluminum titanate.

During its use, it is known that the particulate filter is subjected to a succession of filtration (soot accumulation) and regeneration (soot elimination) phases. During the filtering phases, the soot particles emitted by the engine are retained and deposited inside the filter. During the regeneration phases, the soot particles are burnt off right inside the filter, so as to restore its filtering properties. The porous structure is then heated to temperatures which locally may be above 1000° C. and is subjected, because of very high internal temperature gradients, to intense thermal and mechanical stresses. These stresses may result in microcracking liable over time to result in a severe loss of filtration capability of the unit, or even its complete deactivation. This phenomenon is particularly observed on large-diameter SiC monolithic filters.

To solve these problems and increase the lifetime of the filters, it has more recently been proposed to make more complex filter structures by combining, into an assembled filter structure, several honeycomb monolithic structures or elements. The monolithic elements, after the channels have been alternately plugged so as to define the gas inlet chambers and gas outlet chambers, are joined together by bonding using a cement, of ceramic nature, called in the rest of the description joint cement or joint. Examples of such filter structures are described for example in patent applications EP 816 065, EP 1 142 619 and EP 1 455 923 or else in WO 2004/090294, to which the reader may refer for details about the construction, the synthesis and the implementation of such filters.

It is generally accepted that in this type of structure, so as to ensure better stress relaxation, the thermal expansion coefficients of the various parts of the structure, in particular the filtering elements, and the joint cement must be substantially of the same order of magnitude. Consequently, said parts are currently synthesized from compositions of very similar materials. This choice of materials must also allow, by using a cement having good thermal conductivity, the heat generated by combustion of the soot during regeneration of the filter to be uniformly distributed.

However, the implementation and the lifetime of such assembled structures still pose many problems, especially because of the very nature of the joint cements used and the properties expected of such cements, the adhesion between the various filtering elements being in fact a key point for obtaining such a structure.

In particular, the composition of the initial cement must of course be suitable for providing sufficient adhesion between the various monoliths but without, however, being too high, so as to be able to absorb most of the thermomechanical stresses that are applied to the structure during the successive regeneration phases. Controlling the adhesion between the monoliths and the joint cement, especially at high temperature, thus proves to be of paramount importance for preventing these same monoliths from deteriorating.

In particular, according to the conventional synthesis process, a first assembly of the filter is initially obtained from monoliths synthesized beforehand by means of a loose paste of the joint cement having the rheological properties suitable for applying it between the monoliths and for bonding them. After the cement has been dried at a temperature of around 100° C., allowing it to harden, by elimination of the free water present in the cement, this first assembled structure is usually machined so as to adapt the shapes thereof to its housing in the exhaust line. A coating cement of the same nature is then usually applied on the filter so as to cover the entire external lateral surface thereof, essentially for guaranteeing that the structure is sealed.

Without it being necessary to apply further heating, the filter thus obtained must be able to be directly inserted into an automobile exhaust line, the organic compounds possibly remaining in the cement then being progressively burnt off in the exhaust line during the first regeneration cycles of the filter.

Though such a construction has to result in the end in a large filter more resistant to the thermomechanical stresses mentioned above being obtained, the conventional process for obtaining an assembled structure may however result on the contrary in weakening said structure at certain points because of the very nature of the cement and especially because of its temperature behavior.

Thus, for most of the initial cement compositions described and used hitherto, large quantities of organic agents are used, especially for allowing the joint cement paste to be applied to the external surface of the filtering elements. Some of the organic additives normally used, especially cellulose derivatives or thermosetting resins, also contribute substantially to the adhesion of the filtering elements by the cement joint, especially during the initial assembly phase. Apart from the fact that the addition of these organic compounds in large quantity poses gas evolution problems, it turns out that their presence in the initial composition of the cement, after being initially dried, leads to very variable adhesion properties as a function of the temperature applied to the edifice. Thus, up to a temperature of about 300° C., a very substantial drop in adhesion properties is primarily observed, probably due to the successive elimination of the organic binders in the joint cement composition. The adhesion of the joint and the cohesion of the assembly may therefore become very poor.

Only during a second phase, at temperatures that may even be above 900° C., a substantial increase in the adhesion of the joint cement to the filtering elements is observed because of the sintering of the cement leading to a consolidation reaction of the material by ceramization at higher temperature.

To avoid this problem of loss of adhesion properties of the joint cement at intermediate firing temperatures, typically of around 500° C., it is possible to add colloidal silica to the initial cement mixture as described in particular in patent applications EP 816 065 and EP 1 142 619. However, this addition only has the effect of slightly limiting the observed reduction at these temperatures in the adhesion between the joint cement and the monoliths, but without eliminating it.

Of course, such behavior has an influence on the mechanical and thermomechanical properties of the assembled filter, for the following reasons: during the first firing of the filter, especially upon regeneration that takes place within the exhaust line incorporating the fresh filter, very high temperature gradients necessarily occur inside the filter, the difference in temperature between certain regions of the filter possibly exceeding several tens or even several hundred, degrees Celsius. This results in a high degree of heterogeneity, in the various regions of the filter subjected to different firing temperatures, of the adhesion between the joint cement and the monoliths. In the end, such differences necessarily have the result of greatly weakening the structure in its entirety, right from the first time it is used, and consequently of substantially limiting the lifetime thereof.

In addition to the soot treatment problem, the conversion of the gaseous polluting emissions (i.e. mainly nitrogen oxides (NOₓ) or sulphur oxides (SOₓ) and carbon monoxide (CO), or even unburnt hydrocarbons) into less harmful gases (such as gaseous nitrogen (N₂) or carbon dioxide (CO₂)) requires an additional catalytic treatment. To obtain a structure simultaneously allowing elimination of solid pollutants (soot) and gaseous pollutants, attempts are currently being made to endow the particulate filter with an additional catalytic function. According to the methods described, the honeycomb structure is impregnated with a solution comprising the catalyst or a precursor of the catalyst. Such processes generally include an step of impregnation by immersion either in a solution containing a precursor of the catalyst or the catalyst dissolved in water (or another polar solvent), or in a suspension in water of catalytic particles. As is known, such a process always requires in the end the catalyst to be matured by a final heat treatment carried out at a temperature of around 500° C.

According to another aspect of the technical problem underlying the present invention, the trials carried out by the applicant have also shown that, in the case of such a filter incorporating such a catalytic component, the use of a conventional joint cement may lead to serious cohesion problems of the assembled filter, especially when inserting it into its metal can, for the purpose of integrating the pollution control system within the exhaust line. Most particularly, during such a canning operation, the filter is forcibly inserted into the material, isolating it from the external metal can of the exhaust line. The trials carried out by the applicant have shown that the catalyst maturation temperature (about 500° C.) also corresponds to the point of minimum adhesion between the monoliths (on this subject, see the examples provided in the rest of the description). In many cases, the canning operation then results in disassembly of the assembled filter elements on which the thrust is applied for the insertion thereof, purely because of the excessively low adhesion force of the joint cement.

Because of such problems, for the purpose of obtaining a satisfactory level of adhesion of the joint cement during insertion of the assembled filter into the line, it thus proves necessary at the present time to carry out an additional high-temperature heat treatment of the assembled filter that includes a catalytic component. Such an operation represents a not insignificant additional cost in the overall process for producing catalytic assembled filters.

The object of the present invention is to provide a solution to all the problems described above. More particularly, the invention provides a filter assembled by means of a joint cement, the novel composition of which enables all of the aforementioned technical problems to be effectively solved.

In particular, the assembled structures according to the present invention are characterized by a high, constant and lasting adhesion between the joint cement and the constituent monoliths of said structures right from assembly, but also whatever the temperature level to which they are subsequently subjected, in particular between 300 and 800° C., as will be demonstrated in the rest of the description.

More precisely, the present invention relates to a filter structure, for filtering particulate-laden gases, comprising a plurality of honeycomb filtering elements, said filtering elements comprising an array of longitudinal adjacent channels having mutually parallel axes and separated by porous filtering walls, which comprise or are formed by a material chosen in particular from silicon carbide SiC obtained for example by recrystallization, Si—SiC, silicon nitride, aluminum titanate, mullite or cordierite, in particular SiC or mullite, or a mixture of these materials, said channels being alternately plugged at one or other of the ends of the elements so as to define inlet channels and outlet channels for the gas to be filtered, and so as to force said gas to pass through the porous walls separating the inlet channels from the outlet channels, said structure being obtained by assembling said elements, which are joined together by means of a joint cement, said joint cement being an essentially inorganic, preferably mineral, composite comprising at least:
between 30 and 95% by weight of a filler formed by an assembly of grains, the melting point of which is above 1000° C., said grains having a diameter of greater than 30 microns; and
between 5 and 70% by weight of a binder matrix incorporating a geopolymer phase, said binder matrix comprising, in percentages by weight of the corresponding oxides:
SiO₂: between 20 and 80%,
Al₂O₃: between 3 and 50% and
R₂′O: between 3 and 30%, R₂′O representing the sum of the alkali metal oxides present in the binder matrix.

The percentages by weight are given with the exclusion of water and of the optional organic additives.

In the context of the present invention, the following definitions are given:

The term “filler” is understood to mean an assembly of grains present within the cement for providing essentially the mechanical strength and refractoriness properties thereof.

The expression “diameter of a grain or equivalent diameter of a constituent grain of the joint cement” is understood to mean the average of its largest dimension and its smallest dimension, these dimensions being for example measured conventionally on a section of the joint by scanning microscopy. According to the invention and in accordance with the conventional techniques, it is possible from micrographs of the joint taken with a scanning microscope to measure the diameter of a grain and to identify the grains having a diameter greater than or equal to 30 microns. It is also possible to determine an average diameter corresponding to the representative population of the grains present within said joint. According to the invention, this average diameter is preferably between and 500 microns and in particular very preferably between 100 and 200 microns.

The term “grains” is understood in the context of the present invention to mean particles of a given inorganic material, said particles possibly being solid grains throughout their mass or, in particular, solid or porous and/or hollow spheres.

The term “sphere” is understood to mean a particle having a sphericity, i.e. the ratio of its smallest diameter to its largest diameter, equal to or greater than 0.75 irrespective of the way in which this sphericity was obtained. Preferably, the spheres employed according to the invention have a sphericity equal to or greater than 0.8, preferably equal to or greater than 0.9.

A particle, and in particular a sphere, is said to be “porous” when its porosity is greater than 50% by volume. A sphere is said to be “hollow” when it has a central cavity, whether closed or open to the outside, the volume of which represents at least 50% of the overall external volume of the hollow spherical particle. In particular, the wall thickness is less than 30% of the average diameter of the particles, preferably less than 10% or even less than 5% of said diameter.

The term “silicon nitride” is understood in a general sense to mean a material of the family of SiAlONs, in particular comprising Si₃N₄ in the α- or β-crystallized form, but also Si₂ON₂, or else other phases of the SiAlON family, especially β′, X or O′.

The term “Si—SiC” is understood to mean a material consisting of a mixture of metallic silicon and silicon carbide, preferably in the presence of an optionally crystallized or noncrystallized or partially crystallized phase and composed of a silicate and/or of other oxides so as to protect the metallic silicon from oxidation.

In one particular case for implementing the invention, at least some of the grains according to the invention may take the form of inorganic fibers, i.e. having an elongate structure typically with a diameter of 0.1 to 2 microns and a length ranging up to about 1000 microns.

The term “binder matrix” is understood to mean an entirely crystallized or noncrystallized composition, incorporating a geopolymer phase and establishing a three-dimensional structure between the grains of the filler. In the context of the present invention, the matrix may substantially surround the grains, i.e. at least partially coat them so as to ensure that they are bonded together.

According to the invention, the binder matrix may consist of or essentially comprise the geopolymer phase. Alternatively, the binder matrix may comprise a geopolymer phase and inclusions within said phase, i.e. particles having diameters substantially smaller than 30 microns.

The term “geopolymer”, is understood according to the conventional definition to mean materials of the aluminosilicate type comprising silico-oxo-aluminate (—Si—O—Al—O—) bridging groups, also called “sialates”. In such a structure, the sialate group (Si—O—Al—O—) is a crosslinking agent as shown in the following diagram:

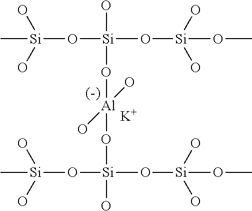

In the structures according to the invention, the geopolymers of the matrix are obtained at room temperature or preferably at temperatures of around 40 to 100° C., in particular between 60 and 90° C., at atmospheric pressure by activating a mixture containing silicon and aluminum by alkali metals (what is called a geosynthesis reaction). More particularly, a geopolymer according to the present invention may be formed by the polymerization and solidification of a mixture comprising an aluminosilicate and an alkali metal silicate, in alkaline medium, especially KOH or NaOH.

The aluminosilicate used according to the present invention may in particular be a metakaolin, a bentonite, an andalusite or another natural mineral, or even a synthetic aluminosilicate depending on the silicon/alumina mass ratio, which is preferably between 1 and 5, more preferably between 1 and 3 and very preferably about 2.

The alkali metal silicate is preferably an Na silicate and/or a K silicate. In the silicate, the SiO₂/(Na₂O+K₂O) molar ratio is preferably between 1 and 3, more preferably between 1.8 and 2.5.

The filter structures according to the invention may preferably and optionally be consistent with at least one of the following features:
the mineral filler is formed from an assembly of refractory grains, the mean diameter of which is between 50 microns and 500 microns;
the binder matrix of the joint cement further contains between 5 and 30% by weight, preferably between 10 and 20% by weight, of inclusions formed by grains having a diameter greater than or equal to 1 micron but less than or equal to 30 microns;
the composition of the binder matrix satisfies the following formulation, in percentages by weight of the oxides:
SiO₂: between 30 and 70%,
Al₂O₃: between 5 and 40%;
K₂O+Na₂O: between 5 and 20%; and
ZrO₂: between 10 and 50%;
the binder matrix has an SiO₂/Al₂O₃ mass ratio and an SiO₂/(Na₂O+K₂O) mass ratio which are both less than 6, preferably less than 5, and preferably greater than 3.5 and even more preferably greater than 4.0;
the binder matrix represents between 10 and 60%, preferably between 25 and 55%, by weight of the mineral matter constituting the joint cement, to the exclusion of water and of the optional organic additives;
the grains constituting the filler represent between 40 and 80% by weight of the mineral matter constituting the joint cement, to the exclusion of water and of the optional organic additives;
the grains constituting the filler comprise or consist of a material chosen from alumina, especially in corundum form, zirconia, silica, titanium oxide, magnesia, aluminum titanate, mullite, cordierite, aluminum titanate, silicon carbide or carbon, in particular in graphite form, or mixtures thereof;
the grains constituting the filler comprise or consist of porous and/or preferably hollow inorganic spheres comprising mostly silica and/or alumina;
the lateral surface of the filter is covered with a peripheral coating consisting of or comprising an essentially inorganic, preferably mineral, composite comprising at least:
a mineral filler formed from refractory grains, the melting point of which is above 1000° C., said grains having a diameter greater than 30 microns; and
a binder matrix incorporating a geopolymer phase, said binder matrix comprising, in percentages by weight of the corresponding oxides:
SiO₂: between 20 and 80%,
Al₂O₃: between 3 and 50% and
R₂′O: between 3 and 30%, R₂′O representing an oxide of an alkali metal or the sum of the alkali metal oxides in the binder phase;
the lateral surface of the filter is covered with a peripheral coating having the same composition as the joint cement; and
further including a supported, or preferably unsupported, active catalytic phase typically comprising at least one precious metal, such as Pt and/or Rh and/or Pd, and optionally an oxide such as CeO₂, ZrO₂ or CeO₂—ZrO₂.

The present invention also relates to an exhaust line, comprising a filter structure as described above.

Finally, the present invention relates to a method of manufacturing a filter as described above, comprising the following steps:
a) preparation of filter monoliths preferably formed by extrusion through a die of a honeycomb structure comprising a plurality of through-channels;
b) plugging of one or other of the ends of the filter monoliths before or after they are fired;
c) preparation of a mixture for obtaining a joint cement, said mixture comprising:
a mineral filler consisting of an assembly of grains, the melting point of which is above 1000° C. and the diameter of which is greater than 30 microns,
an alumina-based compound, preferably a natural or synthetic aluminosilicate, especially a clay, and optionally organic additives for forming the cement, especially organic binders, plasticizers, lubricants, dispersants or deflocculants,
an aqueous solvent, particularly water and
a compound based on silica and an alkali metal oxide or a mixture of precursors thereof, this compound being preferably added after the mineral filler, the alumina compound and the solvent have been added;
d) application of the mixture obtained during step
c) between the monoliths; and
e) geopolymerization heat treatment of the cement, preferably in air and between the ambient temperature and 150° C., so as to obtain an assembled structure comprising the filter monoliths joined by the joint cement.

In one possible embodiment of the invention, the joint material according to the invention covers only a portion, between 10% and 90%, of the total area between the monoliths in the assembly. The joint between two monoliths or filtering elements is thus interrupted. Spacers may be placed between the spots of fresh cement so as to guarantee a defined spacing between two filtering elements. In one embodiment, the fresh cement is applied discontinuously so as to form a plurality of portions locally adapted so as to optimize the attenuation of the thermomechanical stresses liable to be generated. According to the invention, the thickness of the joint between two monolithic elements is typically between 0.5 mm and 2 mm and especially about 1.5 mm (±0.5 mm).

The following adaptations are especially possible:
at least two joint portions comprise materials that differ by their composition and/or their structure and/or their thickness;
the cements of said joint portions have elastic moduli, in particular Young's moduli, differing by 10% or more;
at least one of said joint portions has anisotropic elasticity properties;
said joint portion comprises a silica fabric impregnated with a cement;
the thicknesses of at least two of said joint portions differ by a factor of at least two;
at least one of said joint portions includes a slot;
said slot opens onto one of the upstream or downstream faces of said body;
said slot is formed in a plane substantially parallel to the faces of said monoliths or filtering elements assembled by said joint portion (called “joint faces”);
the length or depth of said slot is between 0.1 and 0.9 times the total length of said body;
said slot is substantially adjacent to one side of said monoliths;
said slot is at least partly filled with a filling material that adheres neither to said block nor to the cement of said joint portion in which block said slot is provided; and
said filling material is boron nitride or silica.

FR 2 833 857 in particular describes a process for manufacturing such joints.

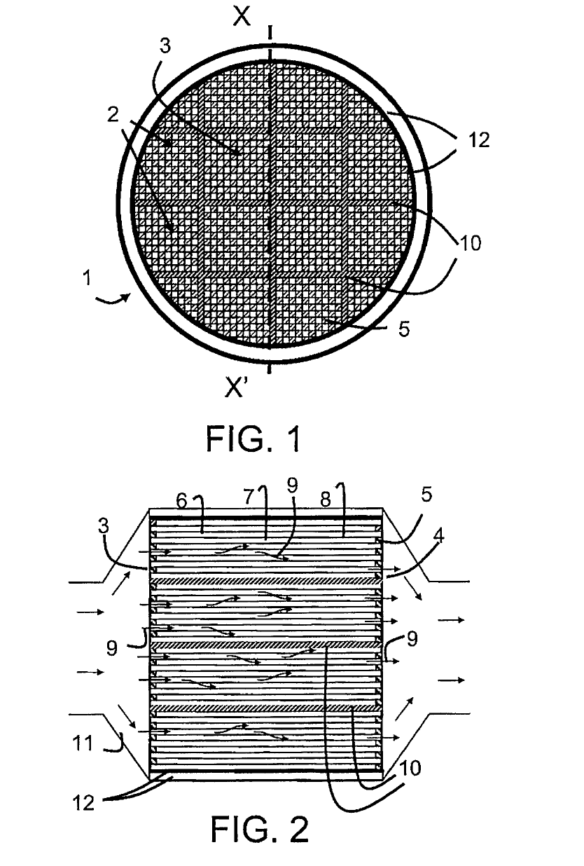

FIG. 1 shows schematically a view of the front face of an assembled filter according to the present invention.

FIG. 2 is a sectional view along the axis X-X′ of the filter of FIG. 1, placed in a metal can.

FIGS. 1 and 2 illustrate an assembled filter 1 according to the invention. As is known, the filter is obtained by assembling unitary monoliths 2 using a joint cement 10. The monoliths 2 themselves are obtained by extruding a loose paste, for example made of silicon carbide, cordierite or aluminum titanate, in order to form a porous honeycomb structure.

Without this being able to be considered as restrictive, porous structures are extruded in the form of monoliths. Each of the monoliths 2 takes the form of a rectangular parallelepiped extending along a longitudinal axis between two substantially square faces, an upstream face 3 and a downstream face 4, opening onto which are a plurality of adjacent rectilinear channels that are parallel to the longitudinal axis.

These extruded porous structures are alternately plugged on their upstream face 3 or on their downstream face 4 by upstream and downstream plugs 5 so as to form respectively outlet channels 6 and inlet channels 7.

Each channel 6 or 7 thus defines an internal volume bounded by sidewalls 8, a closure plug 5 placed either on the upstream face or on the downstream face, and an opening that opens alternately onto the downstream face or the upstream face, in such a way that the inlet and outlet channels are in fluid communication via the sidewalls 8.

The monoliths are assembled together by bonding using the joint cement 10 according to the invention and as described above, i.e. comprising a mixture of a filler consisting of refractory grains bound together by a matrix consisting of or incorporating a phase of the geopolymer type. What is thus obtained in the end is a filter structure or filter assembled as shown schematically in FIGS. 1 and 2. The assembly thus formed may then be machined so as to have, for example, a round or oval cross section, and then possibly covered with a coating cement and/or with an insulating material 12, such as glass wool or rock wool. This results in an assembled filter that can be inserted into an exhaust line 11 using well-known techniques. In operation, the flow of exhaust gases comprising the particulates to be filtered enters the filter 1 via the inlet channels 7, then passes through the filtering sidewalls 8 of these channels before rejoining the outlet channels 6. The propagation of the gases in the filter is illustrated in FIG. 2 by arrows 9.

Nonlimiting examples that follow are given so as to illustrate the advantages associated with implementing the present invention.

### EXAMPLES

1) Production of the Monoliths:

Various silicon carbide honeycomb monolithic elements or monoliths were synthesized using the techniques of the prior art, for example those described in the patents EP 816 065, EP 1 142 619, EP 1 455 923 or WO 2004/090294.

To do so, in a manner similar to the process described in patent application EP 1 142 619, 70% by weight of an SiC powder, the grains of which had median diameter d₅₀ of 10 microns, was mixed in a first step with 30% by weight of a second SiC powder, the grains of which had a median diameter d₅₀ of 0.5 microns. In the context of the present description, the median diameter or d₅₀ denotes the size that divides the particles of this mixture or the grains of this assembly into a first population and a second population that are equal in weight, these first and second populations comprising only particles or grains having a size greater than and less than this median diameter respectively.

Added to this mixture was a pore-forming agent of the polyethylene type, in a proportion equal to 5% by weight of the total weight of the SiC grains, and a processing additive of the methyl cellulose type, in a proportion equal to 10% by weight of the total weight of the SiC grains. Next, the necessary amount of water was added and ingredients were mixed so as to obtain a homogeneous paste, the plasticity of which enabled it to be extruded through a die configured so as to obtain monoliths of square cross section, the internal channels of which had, in cross section, waviness of the walls characterized by a degree of asymmetry equal to 7% in the sense described in patent application WO 05/016491. The structure had a periodicity, i.e. a semi-period p (the distance between two adjacent channels), equal to 1.95 mm.

The green monoliths obtained were dried by microwaves for a time sufficient to bring the chemically non-bound water content to less than 1% by weight.

The channels of each face of the monolith were alternately blocked according to well-known techniques, for example those described in patent application WO 2004/065088.

The monoliths (elements) were then fired in argon with a temperature rise of 20° C./hour until a maximum temperature of 2200° C. was reached, this temperature being maintained for six hours.

The porous material obtained had an open porosity of 47% and a median pore diameter of around 15 microns, as measured by mercury porosymmetry.

The dimensional characteristics of the monoliths thus obtained are given in table 1 below.

TABLE 1

| | |
|---|---|
| Width of the square cross- | 35.8 |
| section monoliths (mm) | |
| Length of the monoliths | 75 |
| (mm) | |
| Periodicity (mm) | 1.95 mm |
| Wall thickness (μm) | 360 |

2) Preparation of the Joint Cement and Assembly of the Monoliths:

The following raw materials were initially used in the present examples for making and implementing the joint cement:

Zircon powders were supplied by CMMP (Comptoir de Minéraux et Matières Premieres) under the reference BRIOREF Primazir 117CM and 325CM.

The compound FZM is a fuse-cast zirconia-mullite (FZM) powder sold by Treibacher.

The hollow microspheres were sold by Omega Minerals under the references W300 and W100.

The porous perlite-type silica particles were sold by CMMP under the reference SilCell 42BC.

The reactive powder Argical M1000 was a metakaolin powder supplied by AGS Minéraux.

The reactive powder Kerphalite KF5 was an andalusite powder supplied by Damrec.

The proportions of the raw materials used for making the initial cement compositions are given in the following table 2 in percentages by weight and for each example.

The sodium silicate used was supplied by PQ Corp. under the reference Crystal 0112. This was an aqueous solution having an Na₂SiO₄ solids content of about 50% by weight.

The cement mixtures comprising the refractory grains and the precursors of the geopolymer (in the form of metakaolin and a natural aluminosilicate) were prepared for all the examples according to the same protocol: the precursors were mixed in a nonintensive planetary mixer according to a conventional procedure comprising:
a dry first mixing step, for two minutes, carried out on the dry raw materials as described in table 2 below, except for the sodium silicate;
addition of water in order to obtain a loose paste;
addition of the sodium silicate; and a second mixing step, for 5 to 10 minutes, until a rheology suitable for its application on the monoliths as a joint cement was obtained.

Typically, the viscosity measured on the initial cement compositions thus obtained was between 5 and 20 mPa·s and preferably between 10 and 13 mPa·s for a shear rate of 12 s⁻¹, as measured using a Haake VT550 viscometer.

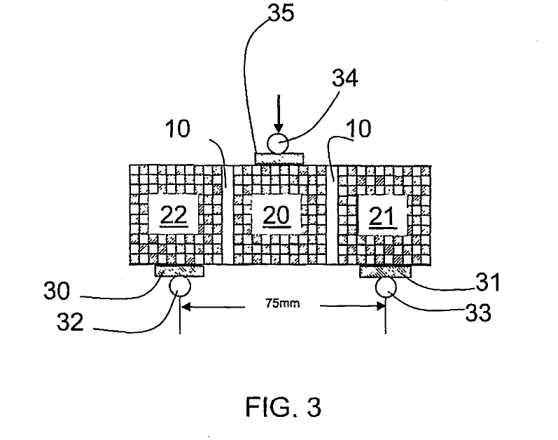

Three parallelepipedal filtering elements 20, 21 and 22 measuring 35.8 mm×35.8 mm×75 mm obtained beforehand were assembled in succession, along one direction, with the cement compositions prepared according to the scheme given in FIG. 3. To maintain a constant thickness of the joint cement 10, shims or “spacers” 1 mm in thickness were placed between the joint faces of the filtering elements to be assembled.

The cement compositions of the joints 10 of the filtering elements 20-22 thus assembled were subjected to a geopolymerization treatment by placing these assemblies in an air oven at 80° C. for two hours.

Various heat treatments were then carried out on the assemblies thus obtained, as indicated in table 3, at increasingly high temperatures. After cooling, the adhesion of the joint cement to the filtering elements was measured for each composition after returning to room temperature. Such heat treatments are representative of the operating conditions of a filter in an exhaust line.

The adhesion force of the joint cement was measured after each heat treatment according to the following adhesion test: the assembly was placed in such a way that the two peripheral filtering elements were supported by rubber support pads 30 and 31 of about 30 mm in length and 5 mm in thickness resting on lower supports 32 and 33 having a diameter of 10 mm, the distance between the centers of these fixed lower supports being 75 mm. The central filtering block 20 was subjected to the pressure of a movable upper ram 34 having a diameter of 10 mm, which was moved downwardly at a rate of 0.5 mm/min, pressing on the metal plate 35 of 30 mm length and 2 mm thickness. The force at which the central filtering block 20 was separated from the assembly formed, by fracture in the joints, was measured. A value corresponding to the stress at break, in MPa, was estimated by dividing this force at break, expressed in N, by the total area A (expressed in mm²) of contact between the central monolith 20 and the joint cements that join it to the two peripheral monoliths 21 and 22 (i.e. A=2×35.8×75 mm²). An adhesive strength equal to or greater than 0.1 MPa was observed as necessary for ensuring sufficient cohesion of the assembly by the cement.

The measurements thus obtained, in MPa and in newtons, are given in tables 2 and 4.

Table 2 gives the percentages by weight of the grains equal to or greater than 30 microns in size. In the tables, unless otherwise indicated, all the percentages are given by weight. These percentages were determined from the particle size distribution curves carried out beforehand on each mineral powder initially used for making up and implementing the joint cement. The particle size distribution curve was obtained by laser particle size analysis. The median diameter of each powder was also determined from these laser particle size measurements. Unless otherwise indicated, all the grain diameters and particle size distributions of the mineral powders according to the present description were determined from data obtained by laser particle size techniques.

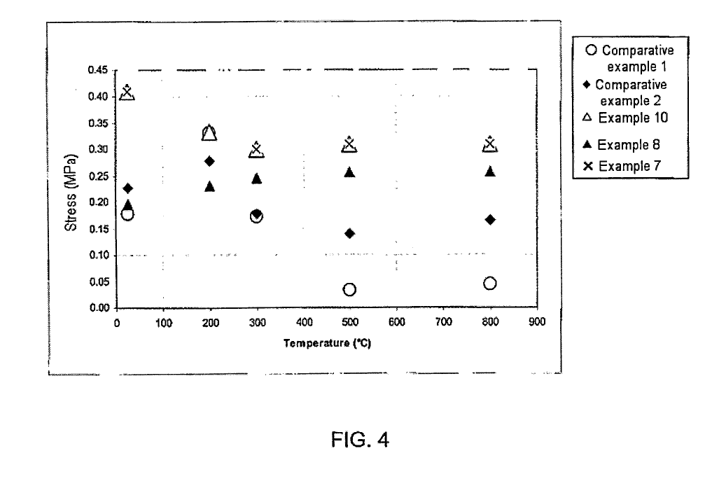

For the purpose of comparison, other monoliths were prepared in the manner described above and assembled with a cement produced according to the conventional techniques represented by example 2 of the patent FR 2 902 424 (comparative example 1 given in table 4 and in FIG. 4). Another comparative example was also produced by adding, to the cement preparation according to example 2 of FR 2 902 424, 18% by weight of a colloidal solution having a silica (SiO₂) solids content of 30% and also 27% of additional water, so as to obtain a constant addition of water and a similar rheology. This comparative example 2 is also given in table 4 and in FIG. 4.

Table 3 shows the adhesion results for the chemical and structural compositions of the joint cement for each of the examples provided.

The percentage content of the geopolymer phase was calculated by summing the contributions, as solids content in percentages by weight, provided by the sodium silicate, the Kerphalite KF5 and the Argical M1000, as initially given in table 2 for each mineral mixture.

The term “mineral mixture” is understood to mean the mixture composed of the mineral powders, i.e. excluding the additions of water, including the water coming from the sodium silicate, and excluding the organic additives.

The percentage by weight of the filler was calculated by summing the contributions, in percentages by weight of the grains having a diameter greater than 30 microns provided by each powder of the mineral mixture except for the sodium silicate, the Kerphalite KF5 and the Argical M1000 participating in the geopolymer phase.

Likewise, the percentage by weight of the inclusions was calculated by adding the contributions, in percentages by weight of the grains having a size equal to or smaller than 30 microns, provided by each powder of the mineral mixture except for the sodium silicate, the Kerphalite KF5 and the Argical M1000 participating in the geopolymer phase.

The percentage by weight of grains having a diameter equal to or smaller than 30 microns and greater than 30 microns was determined for each mineral powder by laser particle size analysis.

The percentages by weight of Al₂O₃, SiO₂, Na₂O+K₂O and ZrO₂, respectively, of the binder matrix (geopolymer phase and inclusions) were deduced from the initial contribution of each mineral compound as introduced into the starting mixture. For each oxide, the chemical contribution of a mineral compound (sodium silicate, Argical and Kerphalite KF5 contributing to the formation of the geopolymer phase and mineral powders in the form of inclusions) was calculated by multiplying the percentage by weight of a compound by the mass content of this compound as this oxide.

The following table summarizes the chemical composition, as equivalent percentages by weight of simple oxide, of each mineral addition in the initial mixture. This data was provided by the manufacturers themselves, or otherwise measured by chemical analysis in the laboratory:

| | Zir- | | Micro- | | | | Crystal |
|---|---|---|---|---|---|---|---|
| | con | FZM | spheres | SilCell | Argical | Kerphalite | 0112 |
| SiO₂ | 33% | 17% | 55% | 73% | 55% | 38% | 66% |
| Al₂O₃ | N | 46% | 35% | 17% | 40% | 61% | N |
| Na₂O + | N | N | N | 8% | N | N | 34% |
| K₂O | | | | | | | |
| ZrO₂ | 66% | 37% | N | N | N | N | N |

N = negligible.

Analysis using a microscope or a wavelength dispersive spectrometer (WDS) on a section of cement material according to examples 8 and 10 has enabled a pointwise elemental analysis to be carried out on each part: filler, inclusion and geopolymer phase. These experimental results confirm the chemical compositions given in table 3 and deduced from the composition of the starting mixture, as described above.

3) Cement/Monolith Adhesion Curve as a Function of Temperature:

In order to make the results given in tables 2, 3 and 4 and their analysis easier to understand, FIG. 4 plots the change in the adhesion force of the cements (measured by the stress at break in MPa) as a function of the heating temperature applied to the cement. It will be immediately seen that the cements according to comparative examples 1 and 2 have extremely low levels of adhesion to the monoliths after heating to 500° C. and removal of the organic binders. Adding colloidal silica (comparative example 2) helps to improve the adhesion, but to levels that are still insufficient for definitely preventing some of the assemblies produced from breaking up. In contrast, the filters assembled using a joint cement incorporating a filler and a geopolymer matrix according to examples 10, 7 and 8 demonstrate improved cohesion of the filtering elements to one another sufficient to guarantee in the end a high degree of integrity of the assembly, whatever the temperature to which it is heated.

4) Analysis of the Results:

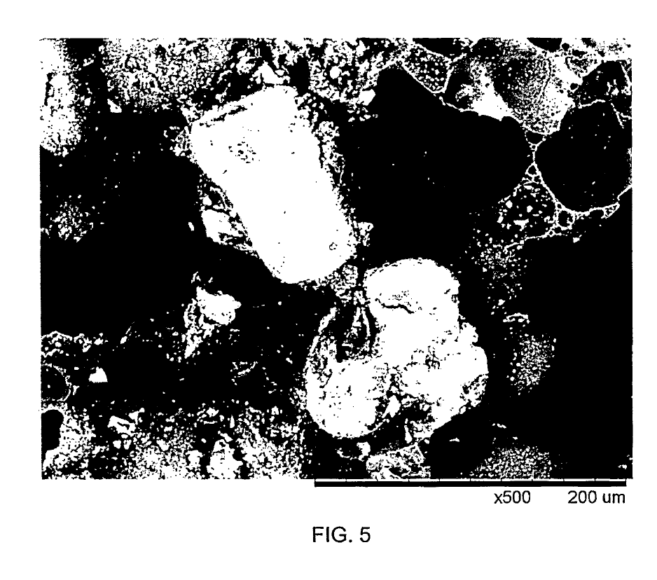

The filler of the cement composition according to example 10, an SEM micrograph of which is given in the appended FIG. 5, consists of a mixture of zircon (bulk: solid) grains and of hollow microspheres consisting of a mixture of alumina and silica, the average diameter of which is greater than 50 microns. The cement composition according to example 10 has ideal physical properties for the envisaged use, especially in terms of primary adhesion to the cement. Very good adhesion enables an extremely strong assembly to be produced right from the lowest temperatures and even at room temperature (25° C.), as may be seen in the graph of FIG. 4. It should be noted that the initial force at 25° C. as plotted in FIG. 4, this time corresponds to the fracture of the central monolithic element and not to limiting adhesion of the cement to said elements. Such a property allows the filter to be handled and installed in the line without any risk.

Furthermore, it may be seen in the graph given in FIG. 4 that the joint cement/monolith adhesion properties can be maintained with temperature: the high initial level of adhesion remains extremely stable with temperature and at very high values, which guarantee the integrity of the assembled structure not only during the first phases of synthesizing and processing the assembled structure, but also throughout its use in an automobile exhaust line. Such properties imply long lifetimes of the filters according to the invention.

The cement composition according to example 7 differs from that of example 10 in that the filler this time consists exclusively of zircon grains, no hollow spheres having been used in the initial composition. The adhesion obtained is very comparable to that of example 10, but the density this time is higher, which may pose a problem if lightweight filters are required, but may be advantageous if it is desired to produce catalyzed filters having a longer light-down time. In this technology, the light-down time is the time for deactivating the catalyst because of the cooling of the exhaust line, for example following a stoppage.

The cement composition according to example 9 also has physical properties similar to those of the cement composition according to example 10, the difference between the compositions of these two cements lying mainly in the lower amount of fines (inclusions) in the cement i.e. amount of grains having a diameter between 1 and 30 microns. The applicant has observed that this finest grain population is in the end predominantly in the form of inclusions in the binder matrix incorporating the geopolymer material.

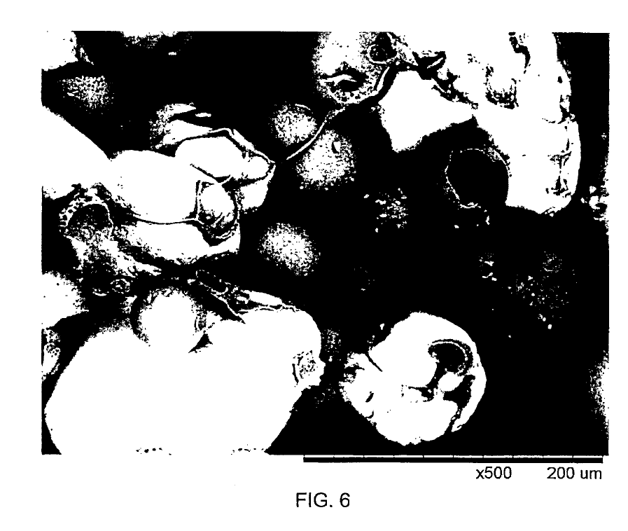

The cement composition according to example 8, an SEM micrograph of which is given in the appended FIG. 6, is characterized by the absence of such inclusions (fine particle fraction) in the matrix, the entire population of the grains present in the cement with a size greater than 30 microns constituting only the filler of the cement in the context of the present invention. The level of adhesion is therefore substantially lower, although however much higher than those of the usual joint cements, illustrated by comparative examples 1 and 2, as shown in table 4 and in FIG. 4. In particular, this figure shows a level of adhesion of the composition of example 8 which is stable with temperature, and sufficient to maintain the cohesion of the assembly, especially at temperatures close to 500° C., for which the levels of adhesion of the usual cements are however unacceptable.

The cement compositions according to examples 5 and 6 are characterized by a lower proportion as a percentage by weight of the geopolymer binder phase i.e. around 20% of the total weight of dry cement, for a level of fines as inclusions of around 10 to 15%, values which are close to the proportion of inclusions in examples 9 and 10 for allowing direct comparison. The adhesion properties here again remain extremely satisfactory right from assembly at ambient temperature and whatever the temperature to which the assembled filter is subsequently subjected.

In the cement compositions according to examples 2 to 4, the composition of the matrix was varied so as to generate different SiO₂/Al₂O₃ and SiO₂/ (Na₂O+K₂O) ratios in accordance with various preferred embodiments of the present invention. For these examples, it may be seen in the data given in table 3 that the strength of adhesion of the cement to the filtering elements decreases strongly when the initial mixture is such that, in the end, the SiO₂/Al₂O₃ and SiO₂/(Na₂O+K₂O) ratios characterizing the geopolymer matrix of the cement are greater than 5 and especially close to 6.

Example 11 also shows that it is possible to obtain a cement having acceptable adhesion properties, although substantially below those of examples 4 to 7 and 9 and 10, using a relatively high percentage by weight of grains constituting the filler.

In the cement composition according to example 1, the Argical was replaced with another aluminosilicate, namely Kerphalite. Here again, the adhesion properties remain excellent.

TABLE 2

| | | | Wt % of | | | | | | |
|---|---|---|---|---|---|---|---|---|---|
| | | | grains > | | | | | | |
| Initial cement composition | | d₅₀ | 30 μm | Ex. 1 | Ex. 2 | Ex. 3 | Ex. 4 | Ex. 5 | Ex. 6 |
| Mineral powders | 117CM zircon (%) | 150 μm | 99% | 51 | 46.2 | 41 | 32.2 | 35.2 | 40.9 |
| contributing to | Alodur FZM zirconia-mullite | 73 μm | 80% | | | | | | |
| the filler and/or | (%) | | | | | | | | |
| to the inclusions | W300 microspheres (%) | 130 μm | 99% | 12.5 | 12.4 | 11 | 8.6 | 20.3 | 17.3 |
| | W100 microspheres (%) | 62 μm | 90% | 7.9 | 8.3 | 7.3 | 5.8 | 8.7 | 11.6 |
| | 325CM zircon (%) | 11 μm | 15% | 17 | 21.5 | 19 | 15 | 15.8 | 10.2 |
| | Sil-Cell of 42-BC particle | 45 μm | 70% | | | | | | |
| | size (%) | | | | | | | | |
| Reactive | Argical M1000 (%) | 10 μm | 0% | | 4.7 | 8.7 | 15.4 | 8.9 | 8.9 |
| aluminosilicate | (metakaolin) | | | | | | | | |
| mineral powder | Kerphalite KF5 (%) | 5 μm | 0% | 4.7 | | | | | |
| Liquid sodium | Sodium silicate | | NA | 7 | 7 | 13 | 23.1 | 11.1 | 11.1 |
| silicate (50 wt % | Crystal 0112 solids content (%) | | | | | | | | |
| solids content) | | | | | | | | | |
| Total mineral mass | Mineral powder masses + solids content of the | | | 100 | 100 | 100 | 100 | 100 | 100 |
| | sodium silicate | | | | | | | | |
| Organic additive: | Xanthan range | | | 0.25 | 0.25 | 0.25 | 0.25 | 0.25 | 0.25 |
| thickener | | | | | | | | | |

| | | | | | | |
|---|---|---|---|---|---|---|
| Added water (excluding water coming | 29.5 | 32.2 | 25 | 5 | 16.5 | 36.6 |
| from the silicate) | | | | | | |
| Added water (with that coming from | 36.5 | 39.2 | 38 | 28.1 | 27.6 | 47.7 |
| the silicate) | | | | | | |

| | | | Wt % of | | | | | |
|---|---|---|---|---|---|---|---|---|
| | | | grains > | | | | | |
| Initial cement composition | | d₅₀ | 30 μm | Ex. 7 | Ex. 8 | Ex. 9 | Ex. 10 | Ex. 11 |
| Mineral powders | 117CM zircon (%) | 150 μm | 99% | 46.3 | 46.3 | 32 | 27.8 | |
| contributing to | Alodur FZM zirconia-mullite | 73 μm | 80% | | | | | 84.7 |
| the filler and/or | (%) | | | | | | | |
| to the inclusions | W300 microspheres (%) | 130 μm | 99% | | 20.2 | 17.7 | 20.2 | |
| | W100 microspheres (%) | 62 μm | 90% | | 5.1 | 7.6 | 5.1 | |
| | 325CM zircon (%) | 11 μm | 15% | 21.1 | | 14.3 | 18.5 | |
| | Sil-Cell of 42-BC particle | 45 μm | 70% | 4.2 | | | | 4.7 |
| | size (%) | | | | | | | |
| Reactive | Argical M1000 (%) | 10 μm | 0% | 12.6 | 12.6 | 12.6 | 12.6 | 4.7 |
| aluminosilicate | (metakaolin) | | | | | | | |
| mineral powder | Kerphalite KF5 (%) | 5 μm | 0% | | | | | |
| Liquid sodium | Sodium silicate | | NA | 15.8 | 15.8 | 15.8 | 15.8 | 5.9 |
| silicate (50 wt % | Crystal 0112 solids content (%) | | | | | | | |
| solids content) | | | | | | | | |
| Total mineral mass | Mineral powder masses + solids content of the | | | 100 | 100 | 100 | 100 | 100 |
| | sodium silicate | | | | | | | |
| Organic additive: | Xanthan range | | | 0.25 | 0.25 | 0.25 | 0.25 | 0.25 |
| thickener | | | | | | | | |

| | | | | | |
|---|---|---|---|---|---|
| Added water (excluding water coming | 26 | 24.4 | 24.6 | 26 | 16.5 |
| from the silicate) | | | | | |
| Added water (with that coming from | 41.8 | 40.2 | 40.4 | 41.8 | 22.4 |
| the silicate) | | | | | |

all the percentages and ratios are given by weight;
NA = not applicable

TABLE 3
Structural and chemical composition of the final cement

| Example | 1 | 2 | 3 | 4 | 5 | 6 | 7 | 8 | 9 | 10 | 11 |
|---|---|---|---|---|---|---|---|---|---|---|---|
| % filler (grains larger in diameter than 30 | 72 | 69 | 61 | 48 | 65 | 70 | 52 | 71 | 58 | 55 | 71 |
| microns) | | | | | | | | | | | |
| % inclusions in the binder matrix (grains not | 16 | 20 | 17 | 14 | 15 | 10 | 20 | 1 | 14 | 17 | 18 |
| exceeding 30 microns) | | | | | | | | | | | |
| % geopolymer phase | 12 | 11 | 22 | 38 | 20 | 20 | 28 | 28 | 28 | 28 | 11 |
| Total % (filler + inclusions + geopolymer | 100 | 100 | 100 | 100 | 100 | 100 | 100 | 100 | 100 | 100 | 100 |
| phase) | | | | | | | | | | | |
| % total binder matrix (geopolymer phase + | 28 | 31 | 39 | 52 | 35 | 30 | 48 | 29 | 42 | 45 | 29 |
| inclusions) | | | | | | | | | | | |
| % SiO₂ in the binder matrix | 42.6 | 44.0 | 49.1 | 54.2 | 49.6 | 52.3 | 50.5 | 60.5 | 52.4 | 50.9 | 35.9 |
| % Al₂O₃ in the binder matrix | 11.5 | 7.0 | 9.6 | 12.2 | 11.3 | 13.2 | 11.0 | 17.9 | 12.9 | 11.7 | 34.1 |
| % Na₂O + K₂O in the binder matrix | 8.6 | 7.6 | 11.3 | 15.0 | 10.8 | 12.4 | 11.4 | 18.1 | 12.8 | 11.9 | 7.4 |
| % ZrO₂ in the binder matrix | 35.9 | 39.5 | 28.0 | 16.5 | 26.1 | 19.7 | 25.2 | 1.0 | 19.7 | 23.4 | 21.4 |
| SiO₂/Al₂O₃ mass ratio in the binder matrix | 3.7 | 6.3 | 5.1 | 4.4 | 4.4 | 4.0 | 4.6 | 3.4 | 4.1 | 4.3 | 1.1 |
| SiO₂/(Na₂O + K₂O) mass ratio in the binder | 4.9 | 5.8 | 4.3 | 3.6 | 4.6 | 4.2 | 4.4 | 3.3 | 4.1 | 4.3 | 4.8 |
| matrix | | | | | | | | | | | |

Results of the adhesion tests

| | | | | | | | | | | | |
|---|---|---|---|---|---|---|---|---|---|---|---|
| After geopolymerization (MPa) | 0.4 | 0.3 | 0.34 | 0.44* | 0.41* | 0.42* | 0.42* | 0.2 | 0.44* | 0.41* | |
| After heating to 500° C. (MPa) | 0.25 | 0.16 | 0.21 | 0.37 | 0.30 | 0.30 | 0.31 | 0.26 | 0.45* | 0.31 | 0.2 |
| After heating to 800° C. (MPa) | | | | | | | 0.31 | | | 0.31 | |
| Density of the cement before drying (g/cm³) | | 1.6 | 1.5 | 1.7 | 1.2 | 1.3 | 1.5 | 1.2 | 1.4 | 1.2 | 1.0 |

*fracture of the central monolith.

TABLE 4

| Heating | Comparative example 1 | | Comparative example 2 | | Ex. 10 | | Ex. 8 | | Ex. 7 | |
|---|---|---|---|---|---|---|---|---|---|---|
| temperature (° C.) | N | MPa | N | MPa | N | MPa | N | MPa | N | MPa |
| 25 | 969 | 0.18 | 1225 | 0.23 | 3000 | 0.41 | 1059 | 0.20 | 3000 | 0.41 |
| 300 | 935 | 0.17 | 966 | 0.18 | 1523 | 0.30 | | | 1509 | 0.30 |
| 500 | 179 | 0.03 | 759 | 0.14 | 1521 | 0.31 | 1386 | 0.26 | 1563 | 0.31 |
| 800 | 234 | 0.04 | 896 | 0.17 | 1539 | 0.31 | | | 1561 | 0.31 |

1. A filter structure, comprising:
a plurality of honeycomb filtering elements comprising an array of longitudinal adjacent channels having mutually parallel axes and separated by porous filtering walls,
wherein the porous filtering walls comprise silicon carbide, Si—SiC, silicon nitride, aluminum titanate, mullite, cordierite, or any mixture thereof,
wherein the channels are alternately plugged at one or other of the ends of the filtering elements so as to define inlet channels and outlet channels configured to filter the a particulate-comprising gas, and to force gas to pass through the porous filtering walls separating the inlet channels from the outlet channels,
wherein the filter structure is obtained by joining the filter elements together with a joint cement, which is an inorganic composite comprising:
from 30 to 95% by weight of a mineral filler comprising an assembly of grains, the melting point of which is above 1000° C., wherein the grains have a diameter of greater than 30 microns; and
from 5to 70% by weight of a binder matrix comprising a geopolymer phase, wherein the binder matrix comprises, by weight percent of the corresponding oxides:
SiO₂: from 20 to 80%;
Al₂O₃: from 3 to 50%;
R₂′O: between from 3 to 30%, wherein R₂′O is the sum of alkali metal oxides present in the binder matrix.

2. The filter structure of claim 1, the mineral filler an assembly of refractory grains having a mean diameter of from 50 to 500 microns.

3. The filter structure of claim 1, in which the binder matrix further comprises from 5 to 30% by weight of inclusions formed by grains having a diameter from 1 to 30 microns.

4. The filter of claim 1, wherein the binder matrix comprises, in percentages by weight of the oxides:
SiO₂: from 30 to 70%;
Al₂O₃: from 5 to 40%;
K₂O+Na₂O: from 5 to 20%; and
ZrO₂: from 10 to 50%.

5. The filter structure of claim 4, wherein the binder matrix has an SiO₂/Al₂O₃ mass ratio and an SiO₂/(Na₂O+K₂O) mass ratio which are both less than 6.

6. The filter structure of claim 1, wherein the binder matrix represents from 10 to 60% by weight of the mineral matter comprised in the joint cement, to the exclusion of water and optional organic additives.

7. The filter structure of claim 1, wherein the grains of the mineral filler represent from 40 to 80% by weight of the mineral matter comprised in the joint cement, to the exclusion of water and optional organic additives.

8. The filter structure of claim 1, wherein the grains of the mineral filler comprise alumina, zirconia, silica, titanium oxide, magnesia, aluminum titanate, mullite, cordierite, aluminum titanate, silicon carbide, carbon, or any mixture thereof.

9. The filter structure of claim 1, wherein the grains of the mineral filler comprise inorganic spheres comprising silica, alumina, or a mixture thereof.

10. The filter structure of claim 1, wherein the lateral surface of the mineral filter comprises a peripheral coating comprising an inorganic composite comprising at least:
a mineral filler comprising refractory grains, the melting point of which is above 1000° C., wherein the grains have a diameter greater than 30 microns; and
a binder matrix comprising a geopolymer phase, wherein the binder matrix comprises, by weight percent of the corresponding oxides:
SiO₂: from 20 to 80%;
Al₂O₃: from 3 to 50%; and
R₂′O: from 3 to 30%, wherein R₂′O is an oxide of an alkali metal or the sum of alkali metal oxides in the binder phase.

11. The filter structure of claim 1, wherein the peripheral coating has the same composition as the joint cement.

12. The filter structure of claim 1, further comprising:
a supported or unsupported active catalytic phase comprising a precious metal and optionally an oxide selected from the group consisting of CeO₂, ZrO₂, and CeO₂—ZrO₂.

13. A method of manufacturing the filter structure of claim 1, the method comprising:
a) forming filter monoliths by extrusion through a die having a honeycomb structure comprising a plurality of through-channels;
b) plugging of one or other of the ends of the filter monoliths before or after they are fired;
c) applying a joint cement mixture comprising between the monoliths, wherein the joint cement mixture comprises:
a mineral filler comprising an assembly of grains, the melting point of which is above 1000° C. and the diameter of which is greater than 30 microns;
an alumina-comprising compound, and optionally at least one organic additive selected from the group consisting of an organic binder, a plasticizer, a lubricant, a dispersant, and a deflocculant;
an aqueous solvent; and
a compound comprising silica and an alkali metal oxide or a mixture of precursors thereof; and
; and
d) geopolymerization heat treating the cement, to obtain an assembled structure comprising the filter monoliths joined with the joint cement.
